(19) United States
(12) Patent Application Publication
(10) Pub. No.: US 2016/0132029 A1
(43) Pub. Date: May 12, 2016

(54) METHOD FOR CONFIGURING AND CONTROLLING SMART HOME PRODUCTS

(71) Applicant: LINCOGN TECHNOLOGY CO LIMITED, Shatin (HK)

(72) Inventor: Kai Chau NG, Macau (HK)

(21) Appl. No.: 14/790,012

(22) Filed: Jul. 2, 2015

(30) Foreign Application Priority Data
Nov. 11, 2014 (HK) 14111378.3

(51) Int. Cl. G05B 15/02; H04L 12/28

(52) U.S. Cl. CPC G05B 15/02; H04L 12/2816

(57) ABSTRACT

Provided is a method for configuring and controlling smart home products, the method comprises the steps of: sending a first signal containing first data by at least one first device or a portal of configuring resources, wherein, said first data contains a configuration file and information of at least one second device; obtaining said first signal by at least one server, assembling the configuration file of said first data and information of at least one said second device, and then saving, while at the same time, generating an identity for each said configuration file; sending said second information containing second data to at least one said first device by at least one said server, wherein said second data is extracted from said configuration file; sharing third data according to said identity by at least one said first device or said server, wherein said third data refers to information of the configuration file corresponding to said identity and said second device; triggering a function of at least one said first device through said configuration file and information of said second device received by at least one said first device. The method can greatly shorten the updating process of the configuration file of the second device by means of coding, assigning ID, and sharing the configuration file of the second device.

### FIELD OF THE INVENTION

The present disclosure relates to the field of communication technology, and more particularly to a method for configuring and controlling smart home products.

### BACKGROUND OF THE INVENTION

Along with the continuous development of communication network technology, the smart home technology has a rapidly development. On the one hand, the user may control the household appliances more conveniently through the smart home technology. For example, the user may control the household appliances through a wireless remote control or a telephone or internet or voice recognition, and also may execute a scenario operation to form a linkage of the plurality of devices. On the other hand, the various devices of the smart home may communicate with each other, and may interactively operate according to different states without the command of the user, thereby giving the user the greatest extent high-efficiency, convenience, comfort and safety.

In the process of realizing the present invention, the inventors have found that at least the following problems present in the prior art.

In the prior art, the smart home relates to a variety of devices and modules, each module is placed dispersedly, each device has its own configuration file, and may be associated with different controller. The configuration file of the controller should be updated so as to control new appliances, when the user use different control device (such as a smart phone, a tablet computer, a conventional computer, etc.), or different users use different control device (such as a different phone or a computer), or changing the control device, the updating process is often time-consuming and cumbersome. This configuration process is especially inconvenient if people only need to control certain appliances temporarily or in a short-term, for example, visiting the home of a friend, during the trip, or in a hotel room.

### SUMMARY OF THE INVENTION

In view of the defects existing in the prior art mentioned above, an object of the present invention is to provide a method for configuring and controlling smart home products, which can observably shorten the updating process of the configuration file of the household appliances through storing the configuration file of the controlled device in the mobile devices or in the portals of resources.

The object of the present invention is realized by the following technical schemes:

A method for configuring and controlling smart home products, said method comprises:

sending a first signal containing first data by at least one first device or a portal of configuring resources, wherein, said first data contains a configuration file and information of at least one second device;

obtaining said first signal by at least one server, assembling the configuration file of said first data and information of at least one said second device, and then saving, while at the same time, generating an identity for each said configuration file;

sending said second information containing second data to at least one said first device by at least one said server, wherein said second data is extracted from said configuration file;

sharing third data according to said identity by at least one said first device or said server, wherein said third data refers to information of the configuration file corresponding to said identity and said second device;

triggering a function of at least one said first device through said configuration file and information of said second device received by at least one said first device.

Wherein, the first device may be a mobile device, it may be a phone, a computer, tablets, a vehicle tracking device, a tag reader, a general-purpose controller, etc. The second device may be household appliances, such as a lighting system, a security system, an access control switch system, a speaker, an air conditioner, a kitchen appliance and so on. Through the steps mentioned above, the information of the second device and the configuration file are in one-to-one correspondence with the identity (ID), the information of the second device and the configuration file are directly shared between the first devices(such as between two phones) or shared through the server, thereby achieving the purpose of saving configuration time.

There are various ways of sharing the information of the second device and the configuration file, for example:

The first sharing way is that directly sharing between the first devices: the first sharing way includes a passive sharing way and an active sharing way. Wherein the passive sharing way shows: the number of said first device is at least two, prior to said step of sharing third data according to said identity by at least one said first device or said server, further comprising:

sharing a request instruction containing said identity to other first devices by one or more of said first devices;

verifying said identity by other first devices receiving said request instruction, and then directly sharing corresponding third data to the first device sharing said request instruction.

The active sharing way shows:

sharing a sharing instruction containing said identity to other first devices by one or more of said first devices;

verifying said identity by the first device receiving said sharing instruction, and then receiving corresponding third data from the first device sharing said sharing instruction.

The second sharing way is that sharing through the server, and also includes a passive sharing way and an active sharing way. Wherein the passive sharing way shows:

sharing a request instruction containing said identity to said server by one or more of said first devices;

identifying said identity by said server, and searching if the third data corresponding to said identity exists;

if it doesn't, returning information that said identity does not exist to said first device sharing said request instruction;

if it does, sharing said request instruction to other first devices;

sharing a sharing instruction or a rejecting instruction to said server by the other first devices, sharing or rejecting to share corresponding third data to the first device sharing said request instruction according to said sharing instruction or said rejecting instruction by the other said first devices.

The active sharing way through the server shows:

sharing a sharing instruction containing said identity to said server by one or more of said first devices;

sharing said sharing instruction to other first devices by said server;

receiving corresponding third data from said server after identifying said identity by the first devices receiving said sharing instruction sahred by said server.

And the active sharing way through the server also can show in another form:

sharing a sharing instruction containing said identity and a secret key to said server by one or more of said first devices;

sharing said sharing instruction and said secret key to other first devices by said server;

receiving corresponding third data from said server, after identifying said identity and said secret key by the first device receiving said sharing instruction.

Except the conditions mentioned above, sharing said sharing instruction or said secret key to said server also may through a portal of configuring resources, such as a service website of a hotel, or a website of household appliance distributors, and so on.

Furthermore, said configuration file also may be updated or upgraded, the step of updating or upgrading comprising:

sharing an updating request containing said identity to the other first devices or said server by at least one said first device;

sharing an updating file to the first device sharing said updating request, after identifying said identity and the version of the configuration file of the first device sharing said updating request.

Preferably, prior to said step of triggering a function of at least one said first device through said configuration file and information of said second device received by at least one said first device, further comprising:

detecting if said second device is in a controllable range by the first device receiving said configuration file and the information of said second device;

if it is, sharing a function instruction to said second device directly;

if not, sharing said function instruction to said server;

sharing said function instruction to the other first devices in the controllable range of said second device by said server, and controlling said second device by said first device.

Wherein, all the information transmitting processes mentioned above may be wireless transmitting processes.

Preferably, said server comprises:

a receiver, configured to receive a signal and an instruction sahred by said first device;

a generator, configured to assemble said configuration file of said first data and information of at least one said second device, and then save, while at the same time, generate an identity for each said configuration file;

a transmitter, configured to share information and signals to said first device.

The present disclosure has following advantages: the configuration file of the second device is assembled and a corresponding identity is distributed, various sharing ways are used, such that the user may directly get the configuration files of some household appliances, and the configuration files are quickly configured, and the user may use these household appliances, thereby saving operation time of the user, and the control of household appliances may be more efficient and more convenient.

### BRIEF DESCRIPTION OF THE DRAWINGS

FIG I is a schematic flow diagram illustrating the method for configuring and controlling smart home products according to one embodiment of the present invention;

FIG. 2 is a schematic flow diagram illustrating the processes of sharing the third data in the first specific embodiment;

FIG. 3 is a schematic flow diagram illustrating the processes of updating of the configuration file in the first specific embodiment;

FIG. 4 is a schematic flow diagram illustrating the processes of sharing the third data in the second specific embodiment;

FIG. 5 is a function flow diagram illustrating the processes of triggering the second device in the second specific embodiment;

FIG. 6 is a schematic flow diagram illustrating the processes of sharing the third data in the third specific embodiment;

FIG. 7 is a schematic flow diagram illustrating the processes of sharing the third data in the fourth specific embodiment;

FIG. 8 is a schematic flow diagram illustrating the processes of sharing the third data in the fifth specific embodiment;

FIG. 9 is a schematic flow diagram illustrating the processes of sharing the third data in the sixth specific embodiment;

FIG. 10 is a schematic flow diagram illustrating the processes of sharing the third data in the seventh specific embodiment;

FIG. 11 is a schematic flow diagram illustrating the processes of sharing the third data in the eighth specific embodiment;

FIG. 12 is a schematic structure diagram illustrating the structure of the server according to one embodiment of present invention.

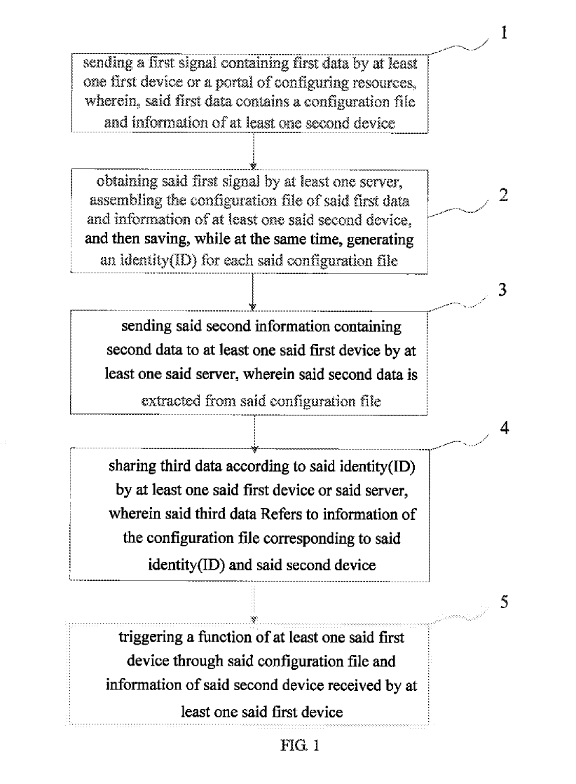

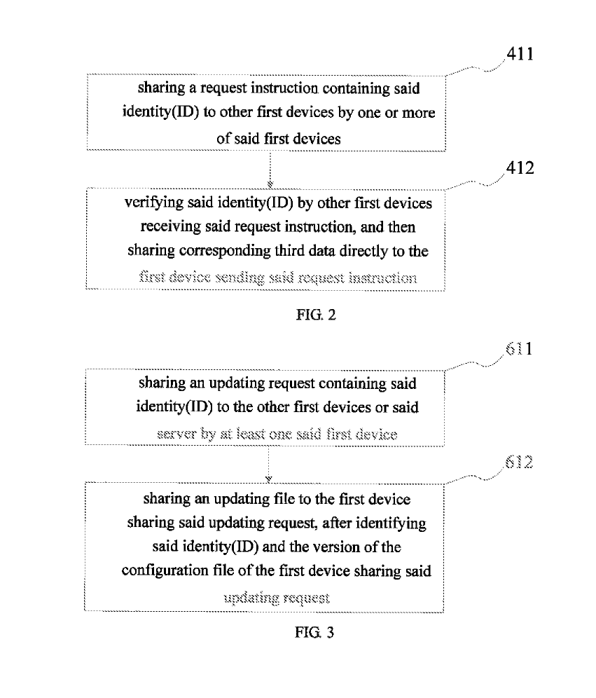

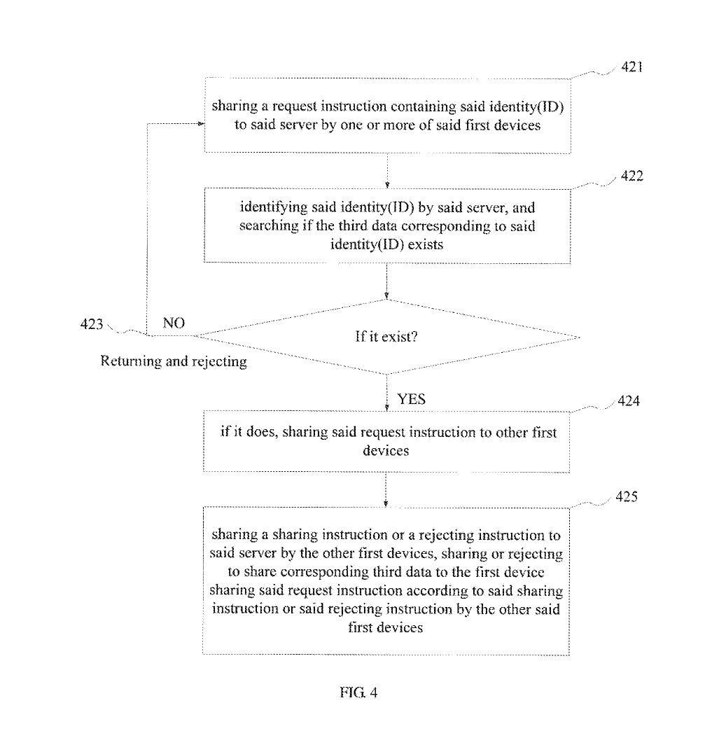

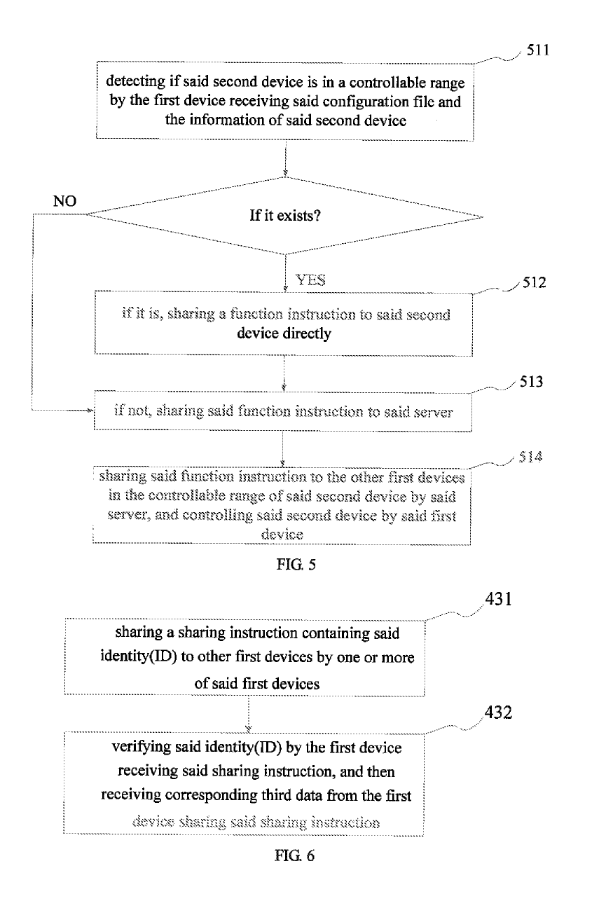

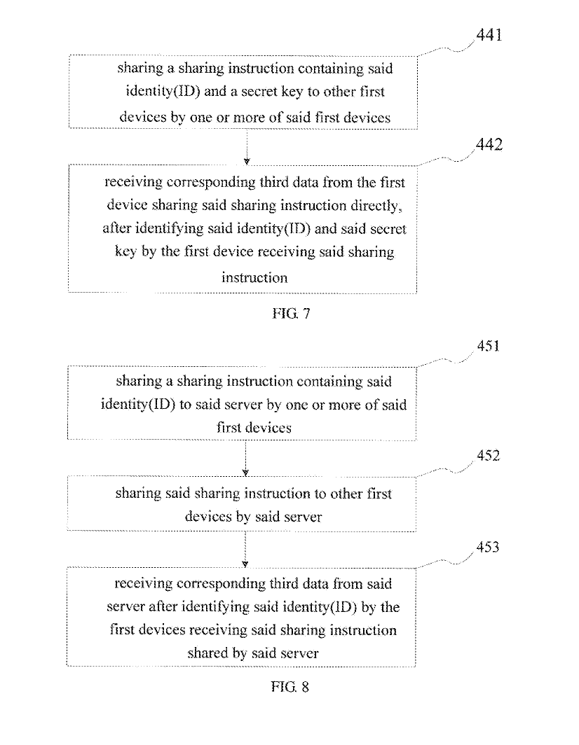

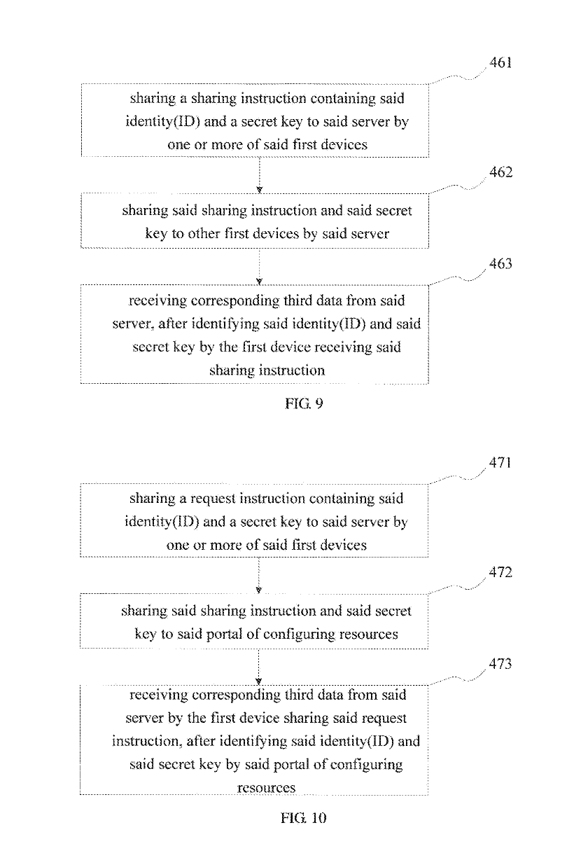

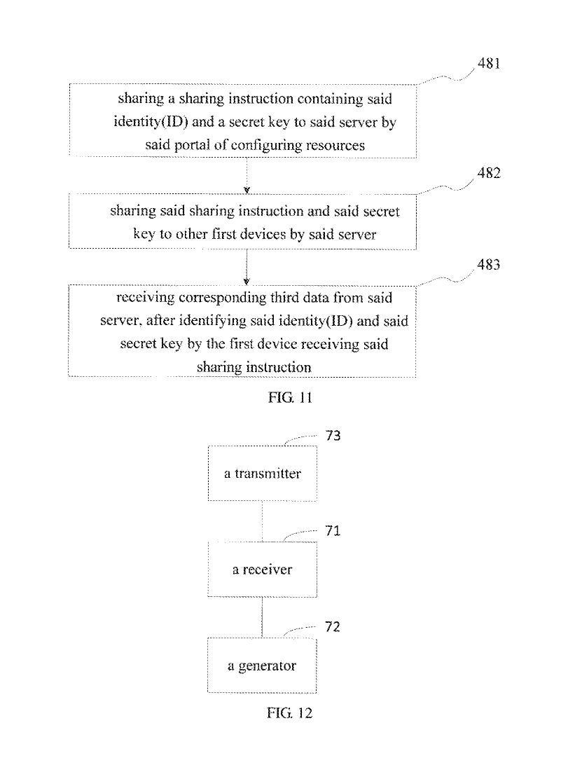

### DETAILED DESCRIPTION OF THE EMBODIMENTS

In order to make the purpose, technical solutions and advantages of the present disclosure to be understood more clearly, the present disclosure will be described in further details with the accompanying drawings and the following embodiments. It should be understood that the specific embodiments described herein are merely examples to illustrate the disclosure, not to limit the present disclosure.

It should be illustrated, in present embodiment, the first device refers to a device providing data connectivity to the user, it may be a wireless electronic device or a cable electronic device. The wireless electronic device may be a handheld device having a wireless connection function, or be other processing devices connected to wireless modems, or be a mobile terminal communicating with one or more core networks through a wireless access network. For example, the wireless electronic device may be a mobile phone (or “cellular phone”) or a computer having a mobile terminal. For another example, the wireless electronic device also may be a mobile device which may be portable, pocket-sized, handheld, build-in a computer or vehicle-mounted. As another example, the wireless electronic device may be a Mobile Station (MS), a Access Point (AP), or an User Equipment (UE), and so on. The second device refers to fitments which are fitted with smart control system, the second device may be light devices, security devices, door control devices, music devices, temperature control devices, humidity control devices, kitchen devices, etc. It should be illustrated that present invention doesn't limit this herein.

The first devices connect to the network through a wired way or a wireless way, or connect to each other through a wired way (such as data line) or a wireless way (such as Bluetooth or other ways), so as to achieve sharing with each other or uniformly controlling to the configuration file of at least one second device.

The server may includes a receiver 71, a generator 72, and a transmitter 73. Wherein, the receiver 71 is used for receiving a signal and an instruction shared by the first device. The generator 72 is used for assembling the configuration file of the first data and information of at least one second device, and then saving, while at the same time, generating an identity (ID) for each said configuration file. The transmitter 73 is used for sharing information and signals to the first device.

FIG. 1 is a schematic flow diagram illustrating the method for configuring and controlling smart home products according to one embodiment of the present invention. As shown in FIG. 1, the specific flow of the method includes:

Step1: sending a first signal containing first data by at least one first device or a portal of configuring resources, wherein, said first data contains a configuration file and information of at least one second device;

Step2: obtaining said first signal by at least one server, assembling the configuration file of said first data and information of at least one said second device, and then saving, while at the same time, generating an identity (ID) for each said configuration file;

Step3: sending said second information containing second data to at least one said first device by at least one said server, wherein said second data is extracted from said configuration file;

Step4: sharing third data according to said identity (ID) by at least one said first device or said server, wherein said third data refers to information of the configuration file corresponding to said identity (ID) and said second device;

Step5: triggering a function of at least one said first device through said configuration file and information of said second device received by at least one said first device.

### First Specific Embodiment

In the first specific embodiment, the sub-process of step 4 mentioned above may includes:

Step411: sharing a request instruction containing said identity (ID) to other first devices by one or more of said first devices;

Step412: verifying said identity (ID) by other first devices receiving said request instruction, and then sharing corresponding third data directly to the first device sending said request instruction.

In present specific embodiment, the sub-process of step 5 mentioned above may includes:

Step511: detecting if said second device is in a controllable range by the first device receiving said configuration file and the information of said second device;

Step512: if it is, sharing a function instruction to said second device directly;

Step513: if not, sharing said function instruction to said server;

Step514: sharing said function instruction to the other first devices in the controllable range of said second device by said server, and controlling said second device by said first device.

### Second Specific Embodiment

In the second specific embodiment, the sub-process of step4 mentioned above may also includes:

Step421: sharing a request instruction containing said identity (ID) to said server by one or more of said first devices;

Step422: identifying said identity (ID) by said server, and searching if the third data corresponding to said identity (ID) exists;

Step423: if it doesn't, returning information that said identity (ID) does not exist to said first device sharing said request instruction;

Step424: if it does, sharing said request instruction to other first devices;

Step425: sharing a sharing instruction or a rejecting instruction to said server by the other first devices, sharing or rejecting to share corresponding third data to the first device sending said request instruction according to said sharing instruction or said rejecting instruction by the other said first devices.

In present the second embodiment, the main process also includes the step of updating or upgrading the configuration file, the step includes:

Step611: sharing an updating request containing said identity (ID) to the other first devices or said server by at least one said first device;

Step612: sharing an updating file to the first device sharing said updating request, after identifying said identity (ID) and the version of the configuration file of the first device sharing said updating request.

### Third Specific Embodiment

In the third specific embodiment, the sub-process of step4 mentioned above may also includes:

Step431: sharing a sharing instruction containing said identity (ID) to other first devices by one or more of said first devices;

Step432: verifying said identity (ID) by the first device receiving said sharing instruction, and then receiving corresponding third data from the first device sharing said sharing instruction.

### Fourth Specific Embodiment

In the fourth specific embodiment, the sub-process of step4 mentioned above may also includes:

Step441: sharing a sharing instruction containing said identity (ID) and a secret key to other first devices by one or more of said first devices;

Step442: receiving corresponding third data from the first device sharing said sharing instruction directly, after identifying said identity (ID) and said secret key by the first device receiving said sharing instruction.

### Fifth Specific Embodiment

In the fifth specific embodiment, the sub-process of step4 mentioned above may also includes:

Step451: sharing a sharing instruction containing said identity (ID) to said server by one or more of said first devices;

Step452: sharing said sharing instruction to other first devices by said server;

Step453: receiving corresponding third data from said server after identifying said identity (ID) by the first devices receiving said sharing instruction sent by said server.

### Sixth Specific Embodiment

In the sixth specific embodiment, the sub-process of step4 mentioned above may also includes:

Step461: sharing a sharing instruction containing said identity (ID) and a secret key to said server by one or more of said first devices;

Step462: sharing said sharing instruction and said secret key to other first devices by said server;

Step463: receiving corresponding third data from said server, after identifying said identity (ID) and said secret key by the first device receiving said sharing instruction.

### Seventh Specific Embodiment

In the seventh specific embodiment, the sub-process of step4 mentioned above may also includes:

Step471: sharing a request instruction containing said identity (ID) and a secret key to said server by one or more of said first devices;

Step472: sharing said sharing instruction and said secret key to said portal of configuring resources;

Step473: receiving corresponding third data from said server by the first device sharing said request instruction, after identifying said identity (ID) and said secret key by said portal of configuring resources.

### Eighth Specific Embodiment

In the eighth specific embodiment, the sub-process of step4 mentioned above may also includes:

Step481: sharing a sharing instruction containing said identity (ID) and a secret key to said server by said portal of configuring resources;

Step482: sharing said sharing instruction and said secret key to other first devices by said server;

Step483: receiving corresponding third data from said server, after identifying said identity (ID) and said secret key by the first device receiving said sharing instruction.

The foregoing examples are preferred embodiments of the present invention only and not intended to limit the present disclosure. It should be understood that, to the person skilled in the art, various modifications and improvements can be made without departing from the spirit and principle of the present disclosure, which should all be included within the scope of the present disclosure. Therefore, the protection scope of the present disclosure shall be defined by the appended claims.

What is claimed is:

1. A method for configuring and controlling smart home products, said method comprises:
sending a first signal containing first data by at least one first device or a portal of configuring resources, wherein, said first data contains a configuration file and information of at least one second device;
obtaining said first signal by at least one server, assembling the configuration file of said first data and information of at least one said second device, then saving, while at the same time, generating an identity for each said configuration file;
sending said second information containing second data to at least one said first device by at least one said server, wherein said second data is extracted from said configuration file;
sharing third data according to said identity by at least one said first device or said server, wherein said third data refers to information of the configuration file corresponding to said identity and said second device;
triggering a function of at least one said first device through said configuration file and information of said second device received by at least one said first device.

2. The method for configuring and controlling smart home products according to claim 1, wherein, the number of said first device is at least two, prior to said step of sharing third data according to said identity by at least one said first device or said server, further comprising:
sharing a request instruction containing said identity to other first devices by one or more of said first devices;
verifying said identity by other first devices receiving said request instruction, and then directly sharing corresponding third data to the first device sending said request instruction.

3. The method for configuring and controlling smart home products according to claim 1, wherein, the number of said first device is at least two, prior to said step of sharing third data according to said identity by at least one said first device or said server, further comprising:
sharing a request instruction containing said identity to said server by one or more of said first devices;
identifying said identity by said server, and searching if the third data corresponding to said identity exists;
if it doesn't, returning information that said identity does not exist to said first device sharing said request instruction;
if it does, sharing said request instruction to other first devices;
sharing a sharing instruction or a rejecting instruction to said server by the other first devices, sharing or rejecting to share corresponding third data to the first device sharing said request instruction according to said sharing instruction or said rejecting instruction by the other said first devices.

4. The method for configuring and controlling smart home products according to claim 1, wherein, the number of said first device is at least two, prior to said step of sharing third data according to said identity by at least one said first device or said server, further comprising:
sharing a sharing instruction containing said identity to other first devices by one or more of said first devices;
verifying said identity by the first device receiving said sharing instruction, and then receiving corresponding third data from the first device sharing said sharing instruction.

5. The method for configuring and controlling smart home products according to claim 1, wherein, the number of said first device is at least two, prior to said step of sharing third data according to said identity by at least one said first device or said server, further comprising:
sharing a sharing instruction containing said identity and a secret key to other first devices by one or more of said first devices;
receiving corresponding third data directly from the first device sharing said sharing instruction, after identifying said identity and said secret key by the first device receiving said sharing instruction.

6. The method for configuring and controlling smart home products according to claim 1, wherein, the number of said first device is at least two, prior to said step of sharing third data according to said identity by at least one said first device or said server, further comprising:
sharing a sharing instruction containing said identity to said server by one or more of said first devices;
sharing said sharing instruction to other first devices by said server;
receiving corresponding third data from said server after identifying said identity by the first devices receiving said sharing instruction shared by said server.

7. The method for configuring and controlling smart home products according to claim 1, wherein, the number of said first device is at least two, prior to said step of sharing third data according to said identity by at least one said first device or said server, further comprising:
sharing a sharing instruction containing said identity and a secret key to said server by one or more of said first devices;
sharing said sharing instruction and said secret key to other first devices by said server;
receiving corresponding third data from said server, after identifying said identity and said secret key by the first device receiving said sharing instruction.

8. The method for configuring and controlling smart home products according to claim 1, wherein, the number of said first device is at least two, prior to said step of sharing third data according to said identity by at least one said first device or said server, further comprising:
sharing a request instruction containing said identity and a secret key to said server by one or more of said first devices;
sharing said sharing instruction and said secret key to said portal of configuring resources;
receiving corresponding third data from said server by the first device sharing said request instruction, after identifying said identity and said secret key by said portal of configuring resources.

9. The method for configuring and controlling smart home products according to claim 1, wherein, the number of said first device is at least two, prior to said step of sharing third data according to said identity by at least one said first device or said server, further comprising:
sharing a sharing instruction containing said identity and a secret key to said server by said portal of configuring resources;
sharing said sharing instruction and said secret key to other first devices by said server;
receiving corresponding third data from said server, after identifying said identity and said secret key by the first device receiving said sharing instruction.

10. The method for configuring and controlling smart home products according to claim 1, wherein, said method further comprises a step of updating or upgrading the configuration file.

11. The method for configuring and controlling smart home products according to claim 10, wherein, prior to said step of updating or upgrading the configuration file, further comprising:
sharing an updating request containing said identity to the other first devices or said server by at least one said first device;
sharing an updating file to the first device sharing said updating request, after identifying said identity and the version of the configuration file of the first device sharing said updating request.

12. The method for configuring and controlling smart home products according to claim 1, wherein, prior to said step of triggering a function of at least one said first device through said configuration file and information of said second device received by at least one said first device, further comprising:
detecting if said second device is in a controllable range by the first device receiving said configuration file and the information of said second device;
if it is, sending a function instruction to said second device directly;
if not, sending said function instruction to said server;
sharing said function instruction to the other first devices in the controllable range of said second device by said server, and controlling said second device by said first device.

13. The method for configuring and controlling smart home products according to claim 1, wherein, said first device is a mobile electronic device having functions of sending, saving, operating and receiving signals, said second device is an appliance having functions of receiving signals and executing instructions.

14. The method for configuring and controlling smart home products according to claim 13, wherein, said server comprises:
a receiver, configured to receive a signal and an instruction shared by said first device;
a generator, configured to assemble said configuration file of said first data and information of at least one said second device, and then save, while at the same time, generate an identity for each said configuration file;
a transmitter, configured to share information and signals to said first device.
